(19) United States
(12) Patent Application Publication
(10) Pub. No.: US 2011/0183285 A1
(43) Pub. Date: Jul. 28, 2011

(54) DENTAL ARTICULATOR WITH INDEPENDENT VERTICAL HEIGHT ADJUSTMENT FOR GAP SPACING

(76) Inventor: Robert Weinhardt, Saline, MI (US)

(21) Appl. No.: 13/011,254

(22) Filed: Jan. 21, 2011

Related U.S. Application Data
(60) Provisional application No. 61/297,355, filed on Jan. 22, 2010.

(51) Int. Cl. A61C 11/02

(52) U.S. Cl. 433/57

(57) ABSTRACT

An improved dental articulator includes an independent vertical adjustment, thereby maintaining a proper plane of occlusion. The vertical height adjustment mechanism enables the upper and lower bows to be spread apart and brought together regardless of the settings of the hinge mechanism. The mechanism may include a single, central threaded rod attached to a manually operated dial, the rotation of which raises and lowers the upper bow and hinge mechanism. The preferred embodiment may further include one or more smooth rods on either side of the threaded rod, each smooth rod being journaled into its own bore to maintain smooth and consistent up and down movements. The rear portion of the upper bow is spring may be biased into opposing retainers on either side in the absence of rocking motion.

### REFERENCE TO RELATED APPLICATIONS

This application claims priority to U.S. Provisional Patent Application Ser. No. 61/297,355, filed Jan. 22, 2010, the entire content of which is incorporated herein by reference.

### FIELD OF THE INVENTION

This invention relates generally to hinged dental articulators and, in particular, to an improved articular having an independent vertical adjustment, thereby maintaining the plane of occlusion.

### BACKGROUND OF THE INVENTION

There are a wide variety of dental articulators, including patented and commercial models. FIGS. 1 and 2 show a dental articulator made by Ray Foster Dental Equipment of Huntington Beach, Calif. The device includes upper and lower bows 102, 104 to receive plaster molds of the upper and lower jaws with teeth to approximate and test bite and other characteristics to manufacture appliances such as bite splints or dentures. In terms of adjustment, the prior art device includes a rod 106 to which the upper bow 102 is attached, allowing the jaws to pivot about the rod, thereby simulating jaw movement. The rod 106 rests on inclined ramps 110, 112 on opposing sides, with an adjustable spring 114 being used to position the rods ends 106, 106′ against stops 116, 118. Overall, the mechanism just described allows for pivoting about rod 106 and a degree of rocking up/down the ramps on either side to approximate condylar movements.

A significant drawback with the prior-art articulator just described is that does not provide for a true vertical adjustment. While it is true that the upper and lower teeth may be opened, this can only be done through tilting about rod 106, which creates a larger gap at the front of the mouth as compared to the molars. With actual human anatomy, however, when a person opens their mouth a drop occurs with respect to back teeth as well as the front teeth, resulting in a gap between the teeth which is more uniform than existing hinged articulators of the type just described can accommodate. The consistent gap maintained between the upper and lower jaws of humans maintains what is called the plane of occlusion. In general terms, existing hinged articulators are incapable of maintaining this plane during operation.

### SUMMARY OF THE INVENTION

This invention improves upon hinged articulators through the provision of an independent vertical adjustment, thereby maintaining the plane of occlusion. The preferred embodiment comprises a rear support structure and upper and lower bows, each with front and rear portions, the rear portion of the lower bow being rigidly coupled to the real support structure. The rear portion of the upper bow is coupled to the rear support structure through a hinge mechanism, the hinge mechanism including a rod enabling the upper bow to tilt up and down about the rod against an adjustable stop, with the rod being retained on ramps inclined upwardly from front to rear enabling a limited degree of rocking of the upper bow.

In contrast to existing articulators, the inventive device includes an independent vertical height adjustment associated with the rear support structure enabling the upper and lower bows to be spread apart and brought together regardless of the settings of the hinge mechanism.

The independent vertical height adjustment may include a single, central threaded rod attached to a manually operated dial, the rotation of which raises and lowers the upper bow and hinge mechanism. The improved articulator may further include one or more smooth rods on either side of the threaded rod, each smooth rod being journaled into its own bore to maintain smooth and consistent up and down movements. The rear portion of the upper bow is spring may be biased into opposing retainers on either side in the absence of rocking motion.

### BRIEF DESCRIPTION OF THE DRAWINGS

FIG. 1 is a first view of a prior art dental articulator;

FIG. 2 is a different view of the dental articulator of FIG. 1;

FIG. 3 is a rear view of the preferred embodiment of the invention;

FIG. 4 is a first top-down view of the preferred embodiment from one perspective; and

FIG. 5 is a second top-down view of the preferred embodiment from a different perspective.

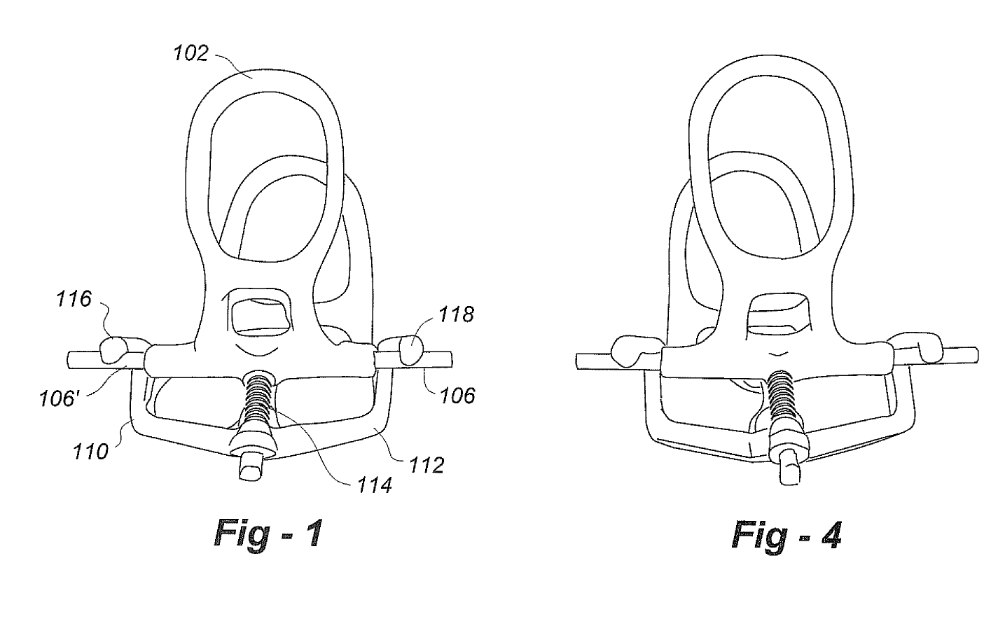

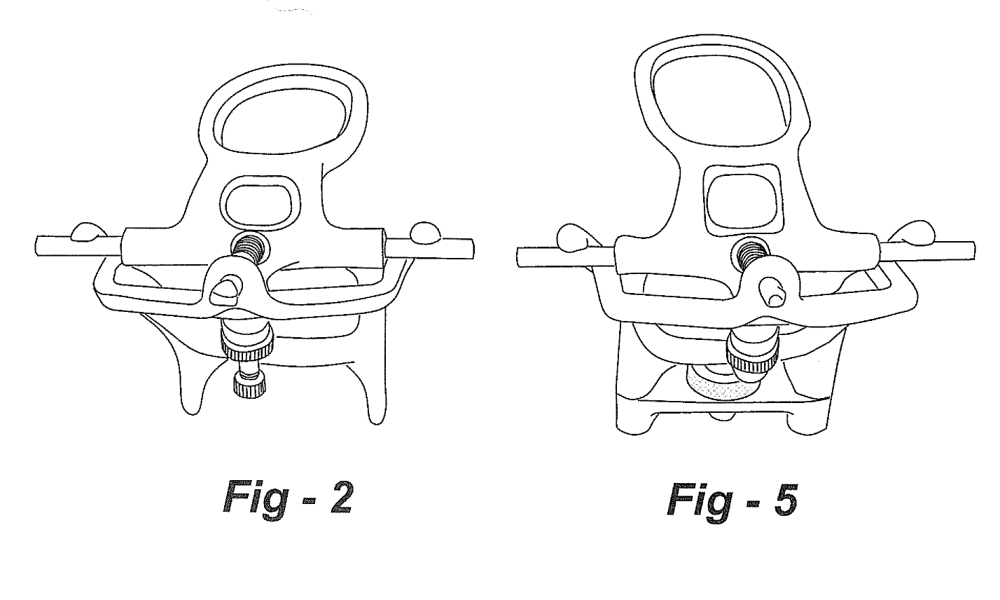

### DETAILED DESCRIPTION OF THE INVENTION

This invention improves upon hinged articulators through the provision of an independent vertical adjustment, thereby maintaining the plane of occlusion. By virtue of this improvement, the gap between teeth may be adjusted independently of condylar hinging and rocking, thereby expediting the manufacture of dental appliances, bite splints in particular. The improved articulator may be constructed of any suitable rigid material including metals and alloys.

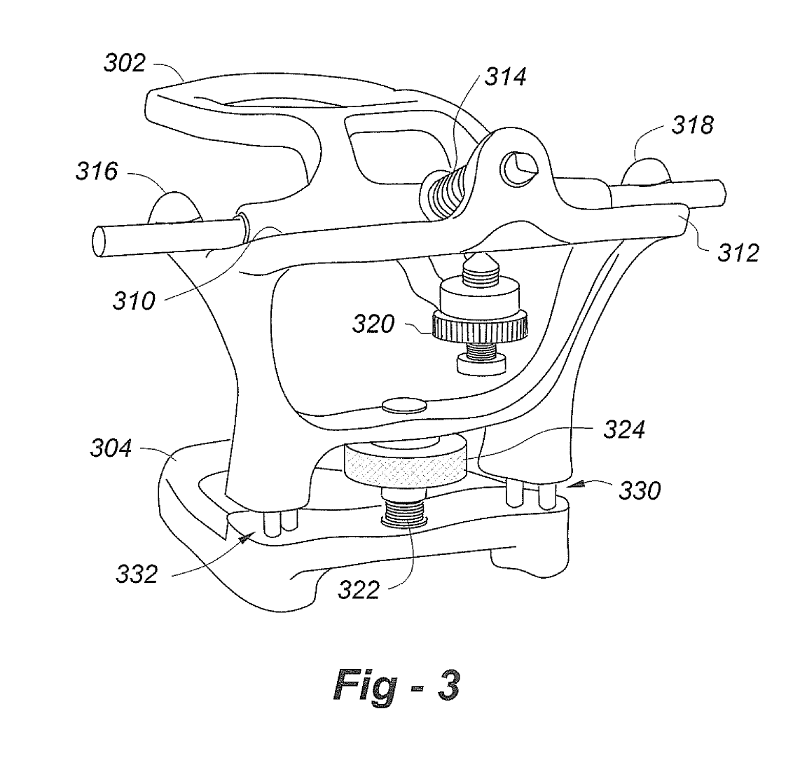

FIG. 3 is a back view of the basic apparatus. FIGS. 4, 5 present different views. As with existing hinged articulators, the device includes upper and lower bows 302, 304, with the upper bow being hinged through a rod 306 biased by spring 314 on ramps 310, 312 against stops 316, 318. Also in common with existing articulators, an adjustable hard stop 320 is provided to terminate the extent of extent of rotation of the upper bow 302. The provision of a hard stop is important with respect to bite splint production, since the jaws are opened and closed multiple times but must return to the same set position.

Thus, so far the components of the inventive articulator may be the same as those of existing hinged articulators. However, in contrast to existing systems, the articulator according to the invention further includes an adjustment allowing the upper and lower bows to be spread apart and brought closer together regardless of the way in which tilt adjustment 320 has been set. In the preferred embodiment, this additional vertical height adjustment takes the form of a threaded rod 322 and knurled dial 324, enabling the upper and lower portions of the device to be spread apart/together by rotating dial 324. Also in the preferred embodiment, one or more additional rods 330, 332 are optionally provided one each side to ensure that the up-and-down movement is smooth and consistent.

I claim:

1. An improved dental articulator, comprising:
a rear support structure;
upper and lower bows, each with front and rear portions, the rear portion of the lower bow being rigidly coupled to the rear support structure;
the rear portion of the upper bow being coupled to the rear support structure through a hinge mechanism, the hinge mechanism including a rod enabling the upper bow to tilt up and down about the rod against an adjustable stop, with the rod being retained on ramps inclined upwardly from front to rear enabling a limited degree of rocking of the upper bow; and
an independent vertical height adjustment associated with the rear support structure enabling the upper and lower bows to be spread apart and brought together regardless of the settings of the hinge mechanism.

2. The improved dental articulator of claim 1, wherein the independent vertical height adjustment includes a single, central threaded rod attached to a manually operated dial, the rotation of which raises and lowers the upper bow and hinge mechanism.

3. The improved dental articulator of claim 2, further including one or more smooth rods on either side of the threaded rod, each smooth rod being journaled into its own bore to maintain smooth and consistent up and down movements.

4. The improved dental articulator of claim 1, wherein the rear portion of the upper bow is spring biased into opposing retainers on either side in the absence of rocking motion.

5. In a dental articulator having upper and lower bows coupled to a hinge mechanism, the improvement comprising:
an independent vertical height adjustment structure enabling the upper and lower bows to be spread apart and brought together regardless of the settings of the hinge mechanism.

6. The improved dental articulator of claim 5, wherein the independent vertical height adjustment includes a single, central threaded rod attached to a manually operated dial, the rotation of which raises and lowers the upper bow and hinge mechanism.

7. The improved dental articulator of claim 5, further including one or more smooth rods on either side of the threaded rod, each smooth rod being journaled into its own bore to maintain smooth and consistent up and down movements.

8. The improved dental articulator of claim 5, wherein the rear portion of the upper bow is spring biased into opposing retainers on either side in the absence of rocking motion.
